(19) United States
(12) Patent Application Publication
(10) Pub. No.: US 2025/0181935 A1
(43) Pub. Date: Jun. 5, 2025

(54) KNOWLEDGE GRAPH CONSTRUCTION AND GRAPH COMPUTING

(71) Applicant: Alipay (Hangzhou) Information Technology Co., Ltd., Hangzhou (CN)

(72) Inventors: Kun TANG, Hangzhou (CN); Peng YI, Hangzhou (CN)

(21) Appl. No.: 18/842,582

(22) PCT Filed: Jan. 10, 2023
(86) PCT No.: PCT/CN2023/071509

§ 371 Date: Aug. 29, 2024

(30) Foreign Application Priority Data
Mar. 1, 2022 (CN) 202210191557.2

(51) Int. Cl. G06N 5/022

(52) U.S. Cl. CPC G06N 5/022

(57) ABSTRACT

According to an example, each piece of first-type service data is modeled as a vertex in a graph; each piece of second-type service data is modeled as an edge in the graph; a structural feature value corresponding to each vertex is obtained based on a predetermined structural feature corresponding to the first-type service data; a structural feature value corresponding to each edge is obtained based on a predetermined structural feature corresponding to the second-type service data, where the structural feature is a feature commonly used in at least two application scenarios; and modeling is performed by using each vertex, the structural feature value of the vertex, each edge, and the structural feature value of the edge, to obtain a structural graph, where each vertex and each edge in the structural graph are mounted with corresponding structural feature values.

### TECHNICAL FIELD

One or more embodiments of this specification relate to computer technologies, and in particular, to a method and apparatus for knowledge graph construction and graph computing.

### BACKGROUND

A graph is an abstract data structure used to represent an association relationship between objects, and is described by using a vertex and an edge, where the vertex represents an object, and the edge represents a relationship between objects. With an explosive increase in information, a knowledge graph is generated based on a graph idea, to reflect a semantic relationship between various types of information. The knowledge graph is essentially a semantic network that reveals a relationship between entities. In the knowledge graph, each vertex in the graph has its own various features, and each edge has its own various features.

In a currently constructed knowledge graph, all features of a vertex and an edge are mounted in the knowledge graph. Consequently, the constructed knowledge graph is excessively large and lacks flexibility. In a process of performing graph computing based on such a knowledge graph, all features of a vertex and an edge are involved in a computing process, and consequently graph computing efficiency is greatly reduced.

### SUMMARY

One or more embodiments of this specification describe a knowledge graph construction method and apparatus and a graph computing method and apparatus, to improve flexibility of knowledge graph construction and improve graph computing efficiency.

According to a first aspect, a knowledge graph construction method is provided. The method includes: modeling each piece of first-type service data as a vertex in a graph; modeling each piece of second-type service data as an edge in the graph; obtaining a structural feature value corresponding to each vertex based on a predetermined structural feature corresponding to the first-type service data; obtaining a structural feature value corresponding to each edge based on a predetermined structural feature corresponding to the second-type service data, where the structural feature is a feature commonly used in at least two application scenarios; and performing modeling by using each vertex, the structural feature value of the vertex, each edge, and the structural feature value of the edge, to obtain a structural graph.

After the obtaining a structural graph, the method further includes: for each vertex in the structural graph, obtaining a current application feature corresponding to a current application scenario from application features corresponding to the first-type service data; for each edge in the structural graph, obtaining a current application feature corresponding to the current application scenario from application features corresponding to the second-type service data, where the application feature is different from the structural feature; and for each vertex in the structural graph, mounting a feature value of the current application feature corresponding to the vertex to the vertex, and for each edge in the structural graph, mounting a feature value of the current application feature corresponding to the edge to the edge, to form a feature map corresponding to the current application scenario.

The method further includes: setting corresponding global IDs for each vertex and each edge; and in a graph feature library, storing and dynamically updating a correspondence between the global ID of each vertex and application features of the vertex, and storing and dynamically updating a correspondence between the global ID of each edge and application features of the edge. Correspondingly, the obtaining a current application feature corresponding to a current application scenario from application features corresponding to the vertex includes: finding application features corresponding to the global ID of the vertex from the graph feature library, and selecting the current application feature applicable to the current application scenario from the found application features; and the obtaining a current application feature corresponding to the current application scenario from application features corresponding to the edge includes: finding application features corresponding to the global ID of the edge from the graph feature library, and selecting the current application feature applicable to the current application scenario from the found application features.

The method is applied to construction of a temporal knowledge graph.

The method is applied to construction of a knowledge graph with temporal transaction service; the first-type service data includes account information; the second-type service data includes a transaction behavior; a structural feature of the vertex includes an account ID; and a structural feature of the edge includes at least one of the following: a time, a transaction ID, and an amount.

According to a second aspect, a graph computing method is provided. The method includes: obtaining a structural graph by using any one of the above-mentioned methods; loading graph structure information in the structural graph, where the graph structure information includes each vertex, each edge, a structural feature value of each vertex, a structural feature value of each edge, and a sequence of vertexes and edges; and performing graph computing by using the loaded graph structure information, to obtain a flow path.

After the obtaining a structural graph, the graph computing method further includes: performing graph computing corresponding to a current application scenario by using a feature map corresponding to the current application scenario and the flow path.

According to a third aspect, a knowledge graph construction apparatus is provided. The apparatus includes: a model establishment module, configured to: model each piece of first-type service data as a vertex in a graph; and model each piece of second-type service data as an edge in the graph; a structural feature selection module, configured to: obtain a structural feature value corresponding to each vertex based on a predetermined structural feature corresponding to the first-type service data; and obtain a structural feature value corresponding to each edge based on a predetermined structural feature corresponding to the second-type service data, where the structural feature is a feature commonly used in at least two application scenarios; and a structural graph construction module, configured to perform modeling by using each vertex, the structural feature value of the vertex, each edge, and the structural feature value of the edge, to obtain a structural graph.

The apparatus further includes: an application feature selection module, configured to: for each vertex in the structural graph, obtain a current application feature corresponding to a current application scenario from application features corresponding to the vertex; and for each edge in the structural graph, obtain a current application feature corresponding to the current application scenario from application features corresponding to the edge, where the application feature is different from the structural feature; and a feature map construction module, configured to: for each vertex in the structural graph, mount a feature value of the current application feature corresponding to the vertex to the vertex, and for each edge in the structural graph, mount a feature value of the current application feature corresponding to the edge to the edge, to form a feature map corresponding to the current application scenario.

According to a fourth aspect, a graph computing apparatus is provided. The apparatus includes: a knowledge graph construction apparatus; and a flow path computing module, configured to: load graph structure information in a structural graph, where the graph structure information includes each vertex, each edge, a structural feature value of each vertex, a structural feature value of each edge, and a sequence of vertexes and edges; and perform graph computing by using the loaded graph structure information, to obtain a flow path.

The graph computing apparatus further includes a service analysis module, configured to perform graph computing corresponding to a current application scenario by using a feature map corresponding to the current application scenario and the flow path.

According to a fifth aspect, a computing device is provided, and includes a memory and a processor. The memory stores executable code therein, and when the processor executes the executable code, the method according to any embodiment of this specification is implemented.

According to the knowledge graph construction method and apparatus and the graph computing method and apparatus provided in the embodiments of this specification, modeling and computing are not performed by using all features of a vertex and an edge, but modeling and computing are performed by using only structural features corresponding to the vertex and the edge. Because the structural feature is a feature commonly used in a plurality of application scenarios, the structural feature is a part of all the features of the vertex or the edge. Therefore, the obtained structural graph is a knowledge graph that can be commonly used in various application scenarios and that has a simplified structure (or a framework structure). In view of a current explosive increase in an information volume and graph computing such as graph computing at a level of tens of billions, based on the knowledge graph constructed in the embodiments of the specification, a quantity of features used in a graph computing process is greatly reduced, and graph computing efficiency is greatly improved.

### BRIEF DESCRIPTION OF DRAWINGS

To describe the technical solutions in the embodiments of this specification or in the conventional technology more clearly, the following briefly describes the accompanying drawings needed for describing the embodiments or the conventional technology. Clearly, the accompanying drawings in the following descriptions show some embodiments of this specification, and a person of ordinary skill in the art can still derive other drawings from these accompanying drawings without creative efforts.

FIG. 1 is a schematic diagram of a knowledge graph of a temporal transaction service in the conventional technology;

FIG. 2 is a flowchart of a knowledge graph construction method according to an embodiment of this specification;

FIG. 3 is a schematic diagram of a structural graph of a temporal transaction service according to an embodiment of this specification;

FIG. 4 is a flowchart of a knowledge graph construction method in an application scenario according to an embodiment of this specification;

FIG. 5 is a schematic diagram of composition of a constructed knowledge graph according to an embodiment of this specification;

FIG. 6 is a flowchart of performing graph computing based on a structural graph according to an embodiment of this specification;

FIG. 7 is a flowchart of performing graph computing in an application scenario according to an embodiment of this specification;

FIG. 8 is a schematic structural diagram of a knowledge graph construction apparatus according to an embodiment of this specification;

FIG. 9 is a schematic structural diagram of a knowledge graph construction apparatus according to another embodiment of this specification;

FIG. 10 is a schematic structural diagram of a graph computing apparatus according to an embodiment of this specification; and

FIG. 11 is a schematic structural diagram of a graph computing apparatus according to another embodiment of this specification.

### DESCRIPTION OF EMBODIMENTS

As described above, in the conventional technology, when a knowledge graph is constructed, all features of a vertex and an edge are involved in a modeling process. Correspondingly, in any application scenario, all the features of the vertex and the edge are used when graph computing is performed. Consequently, the knowledge graph is excessively large, and graph computing efficiency is greatly reduced.

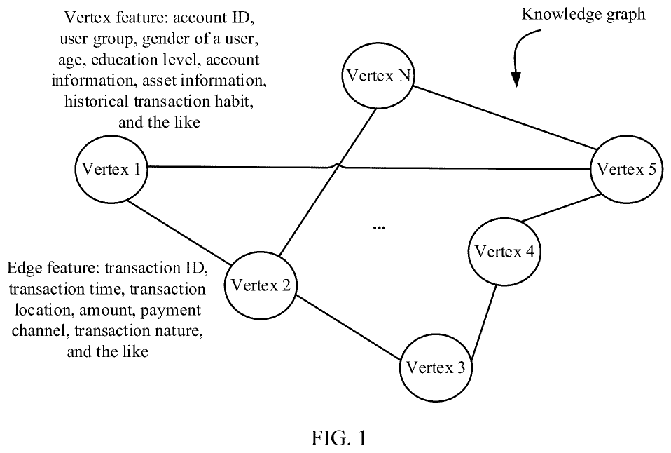

For example, a knowledge graph of a temporal transaction service is used as an example. As shown in FIG. 1 (it can be understood that a quantity of vertexes shown in FIG. 1 is merely an example, where N is a positive integer), in the graph, a vertex is account information of a user, and an edge is a transaction behavior between users. In this case, features included in each vertex involve all features of an account, for example, various types of information such as an account ID, a user group, a gender of a related user, an age, an education level, account information, asset information, and a historical transaction habit, and features included in each edge involve all features of one transaction, for example, a transaction ID, a transaction time, a transaction location, an amount, a payment channel, and transaction nature, for example, whether the transaction is a violation transaction. With an explosive increase in network information, a knowledge graph includes a large quantity of vertexes and edges. Therefore, the knowledge graph is excessively large and lacks flexibility. In addition, a magnitude of graph computing is usually at a level of tens of billions or more. If all features of each vertex and each edge are involved in modeling and computing processes, graph computing efficiency is definitely greatly reduced. For example, in the graph computing process, a computing party needs to store all features of the vertex and all features of the edge for loading and use during computing. In this way, a large quantity of storage resources of the computing party are occupied. For another example, if all the features of each vertex and each edge are involved in the graph computing process, computing resources of a computing party are greatly occupied.

The solutions provided in this specification are described below with reference to the accompanying drawings.

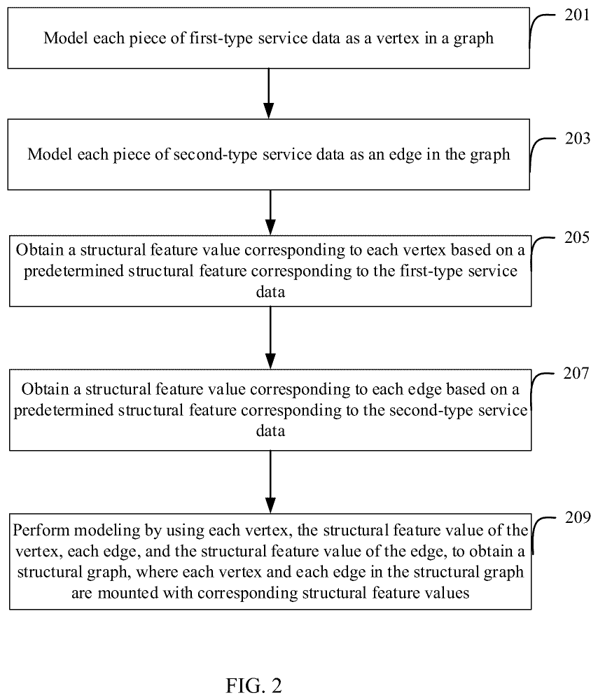

FIG. 2 is a flowchart illustrating a knowledge graph construction method according to an embodiment of this specification. The method is performed by a knowledge graph construction apparatus. It can be understood that the method can alternatively be performed by any apparatus, device, platform, or device cluster having computing and processing capabilities. With reference to FIG. 2, the method includes the following steps.

Step 201: Model each piece of first-type service data as a vertex in a graph.

Step 203: Model each piece of second-type service data as an edge in the graph.

Step 205: Obtain a structural feature value corresponding to each vertex based on a predetermined structural feature corresponding to the first-type service data.

Step 207: Obtain a structural feature value corresponding to each edge based on a predetermined structural feature corresponding to the second-type service data.

The structural feature is a feature commonly used in at least two application scenarios.

Step 209: Perform modeling by using each vertex, the structural feature value of the vertex, each edge, and the structural feature value of the edge, to obtain a structural graph, where each vertex and each edge in the structural graph are mounted with corresponding structural feature values.

It can be learned that in the knowledge graph construction process shown in FIG. 2, modeling is not performed by using all features of a vertex and an edge, but modeling is performed by using only structural features corresponding to the vertex and the edge. Because the structural feature is a feature commonly used in a plurality of application scenarios, the structural feature is a part of all the features of the vertex or the edge. Therefore, the obtained structural graph is a knowledge graph that can be commonly used in various application scenarios and that has a simplified structure (or a framework structure), and this knowledge graph is more flexible.

Each step in FIG. 2 is separately described below with reference to the accompanying drawings and a specific example.

First, for step 201, each piece of first-type service data is modeled as a vertex in a graph.

In this step, any type of service data that can represent an object can be modeled as a vertex in a graph. For example, for a transaction service, account information can be modeled as a vertex in a graph. Herein, an account can be obtained through division based on a product/container. That is, different products/containers of the same user correspond to different account information, that is, correspond to different vertexes. For example, a bank account of a user A corresponds to a vertex 1, and a WeChat account of the user A corresponds to a vertex 2.

Then, for step 203, each piece of second-type service data is modeled as an edge in the graph.

In step 203, any type of service data that can represent a relationship between two objects can be modeled as an edge in the graph. For example, for the transaction service, a transaction behavior can be modeled as an edge in the graph.

The structural feature and the application feature are predefined in the embodiments of this specification. The structural feature is a feature commonly used in at least two application scenarios. That is, the structural feature is a feature to which attention is paid in a plurality of application scenarios and that is used to perform service analysis and computing in a plurality of application scenarios. The application feature is a remaining feature other than the structural feature, and different application scenarios correspond to respective application features.

To improve graph computing efficiency, in the embodiments of this specification, a structural feature is selected in advance from various types of features of a vertex and an edge. Because the structural feature is only a part of a plurality of types of features, it can be ensured that a quantity of features used in a graph computing process is greatly reduced, to improve computing efficiency. In addition, because the structural feature is a feature commonly used in at least two application scenarios, a structural graph obtained in the graph computing process can reflect a common path and flow status applicable to various application scenarios, and can be used for analysis of subsequent application scenarios, that is, used to ensure that subsequent service analysis can be performed.

For example, the transaction service is used as an example. During modeling, in the graph, the vertex is account information, and the edge is a transaction behavior between two accounts. That is, the first-type service data is various types of account information, and the second-type service data is various transaction behaviors. A feature that corresponds to this type of service data, that is, the account information, and that can be commonly used in various application scenarios is an account ID, that is, the account ID is used regardless of subsequent service analysis in any application scenario. A feature that corresponds to this type of service data, that is, the transaction behavior, and that can be commonly used in various application scenarios is at least one of an amount, a time, and a transaction ID, that is, at least one of the amount, the time, and the transaction ID is used regardless of subsequent service analysis in any application scenario. Therefore, a structural feature corresponding to the account information (that is, the first-type service data) is predefined as the account ID. In this way, an application feature corresponding to the account information is a feature other than the account ID, for example, includes various types of information such as a user group, a name of a user corresponding to the account, a gender, an age, an education level, information about a bank to which the account belongs, asset information, and a historical transaction habit. In addition, a structural feature corresponding to the transaction behavior (that is, the second-type service data) is predefined to include the time, the transaction ID, and the amount. An application feature corresponding to the transaction behavior is a feature other than the time, the transaction ID, and the amount, for example, includes a transaction location, a payment channel, a transaction scenario, whether the transaction succeeds, and transaction nature, for example, whether the transaction is complained of as a violation transaction.

Then, for step 205, a structural feature value corresponding to each vertex is obtained based on a predetermined structural feature corresponding to the first-type service data; and for step 207, a structural feature value corresponding to each edge is obtained based on a predetermined structural feature corresponding to the second-type service data.

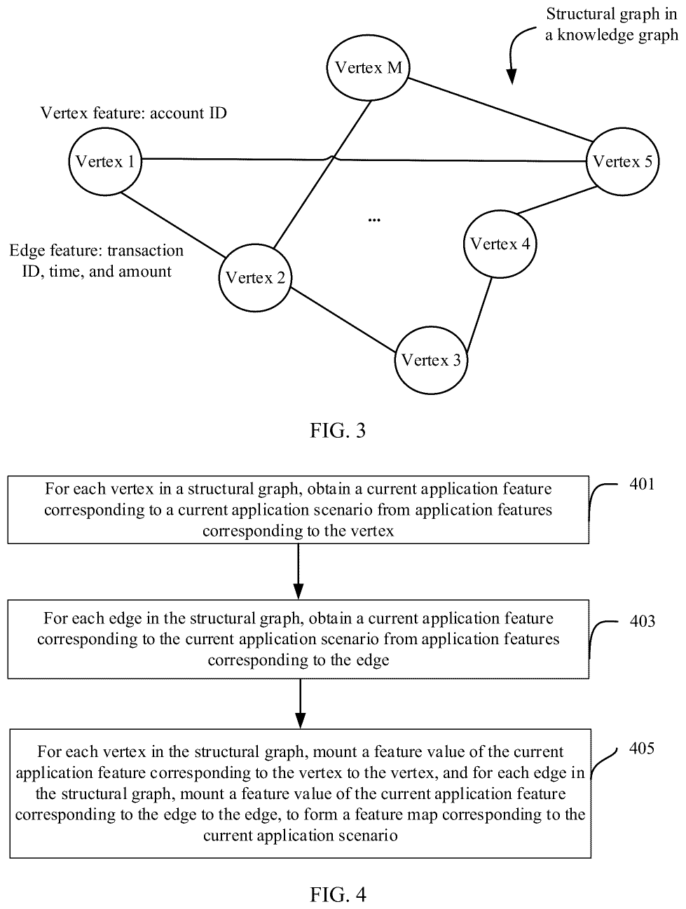

For example, the above-mentioned temporal transaction service is still used as an example. As shown in FIG. 3, during modeling, each vertex obtains only and is mounted with a feature value of a structural feature, that is, an account ID, for example, for a vertex 1, an account ID is 2088 . . . 0001,and for a vertex 2, an account ID is 5338 . . . 1005; and each edge obtains only and is mounted with feature values of three structural features, that is, an amount, a time, and a transaction ID, for example, for an edge 1, an amount is 200 yuan, a time is 10:00 on Jan. 5, 2021, and a transaction ID is 10000001, and for an edge 2, an amount is 200000 yuan, a time is 21:00 on Feb. 15, 2021, and a transaction ID is 16009801.

Then, for step 209, modeling is performed by using each vertex, the structural feature value of the vertex, each edge, and the structural feature value of the edge, to obtain a structural graph, where each vertex and each edge in the structural graph are mounted with corresponding structural feature values.

The structural graph obtained in step 209 is a knowledge graph that is in a form of a framework and that has a simplified structure, and is a knowledge graph commonly used in a plurality of application scenarios.

As described above, in the conventional technology, all features of a vertex and all features of an edge are constructed in a knowledge graph. However, different application features are usually used in different application scenarios except that structural features are commonly used in various application scenarios. Therefore, in the embodiments of this specification, a feature map dedicated to an application scenario can be constructed for the application scenario, and feature maps in different application scenarios are usually different. With reference to FIG. 4, in an embodiment of this specification, after step 209, a process of constructing a feature map dedicated to an application scenario includes the following steps.

Step 401: For each vertex in the structural graph, obtain a current application feature corresponding to a current application scenario from application features corresponding to the first-type service data.

Step 403: For each edge in the structural graph, obtain a current application feature corresponding to the current application scenario from application features corresponding to the second-type service data, where the application feature is different from the structural feature.

Step 405: For each vertex in the structural graph, mount a feature value of the current application feature corresponding to the vertex to the vertex, and for each edge in the structural graph, mount a feature value of the current application feature corresponding to the edge to the edge, to form a feature map corresponding to the current application scenario.

The following describes the process shown in FIG. 4.

As described above, application features corresponding to a vertex and application features corresponding to an edge are predefined. When analysis and computing are performed in different application scenarios, used application features are not exactly the same. For example, in an application scenario of fraud analysis, during graph computing, an application feature that needs to be used by a vertex includes a historical transaction habit of a user corresponding to an account, an application feature that does not need to be used by the vertex includes a gender of the user corresponding to the account, an application feature that needs to be used by an edge includes whether a transaction is complained of as a violation transaction, and an application feature that does not need to be used by the edge includes whether the transaction succeeds. However, in an application scenario of money laundering analysis, during graph computing, an application feature that needs to be used by a vertex includes a name of a user corresponding to an account and asset information, an application feature that does not need to be used by the vertex includes an education level of the user corresponding to the account, an application feature that needs to be used by an edge includes a transaction location, and an application feature that does not need to be used by the edge includes whether the transaction is complained of as a violation transaction.

Therefore, when analysis needs to be performed for a specific current application scenario, a current application feature of a vertex corresponding to the current application scenario instead of all application features of the vertex and a current application feature of an edge corresponding to the current application scenario instead of all application features of the edge can be first obtained by using the process shown in FIG. 4. After the above-mentioned feature map is formed, a feature map that is specifically applicable to the current application scenario is obtained. It can be understood that by using the method in FIG. 4, different feature maps are usually obtained for different application scenarios. In this way, if a dedicated feature map corresponding to an application scenario is used to perform graph computing, targeted analysis can be performed to obtain an analysis result corresponding to the application scenario, for example, whether there is gambling or fraud.

In the embodiments of this specification, a graph feature library can be established in advance. During modeling, all application features that are not used in the structural graph are first stored in the graph feature library, and can be stored based on a correspondence between an ID number and an application feature during storage, that is, corresponding global IDs are separately set for each vertex and each edge. This can uniquely identify a vertex and an edge in an entire link. In the graph feature library, a correspondence between the global ID of each vertex and application features of the vertex is stored and dynamically updated. In addition, in the graph feature library, a correspondence between the global ID of each edge and application features of the edge is stored and dynamically updated. For example, in FIG. 3, a correspondence between a global ID of the vertex 1 and application features of the vertex 1 is stored in the graph feature library, and a correspondence between a global ID of the edge 1 and application features of the edge 1 is stored in the graph feature library.

When an application feature corresponding to a vertex or an edge is updated, in the embodiments of this specification, only dynamic update in an offline manner needs to be performed in the graph feature library, and the structural graph does not need to be updated. In the conventional technology, because a full-link graph is constructed, all features are loaded on a vertex or an edge. If a feature needs to be added or removed, a full-link configuration needs to be modified. It can be learned that in the embodiments of this specification, the graph feature library is dynamically updated, which greatly reduces a workload and improves flexibility of a graph computing service.

In this way, a specific implementation process of step 401 includes: finding application features corresponding to the global ID of the vertex from the graph feature library, and selecting the current application feature applicable to the current application scenario from the found application features; and a specific implementation process of step 403 includes: finding application features corresponding to the global ID of the edge from the graph feature library, and selecting the current application feature applicable to the current application scenario from the found application features.

In the embodiments of this specification, all application features are first stored in the graph feature library. In a process of obtaining a structural graph through computing, none of all the application features needs to be transferred between vertexes through message transmission, and only when service analysis and computing are performed for a specific application scenario, an application feature corresponding to this application scenario needs to be found from the graph feature library. Therefore, computing efficiency is greatly improved.

It can be learned, with reference to the processes shown in FIG. 2 and FIG. 4, that in the embodiments of this specification, a manner of first separating and then mounting is used. That is, all features of the vertex and the edge are first separated, that is, the structural feature and the application feature are separated, to obtain a structural graph by using the simplified feature; and then the separated specific application feature is mounted to the structural graph based on an application scenario, that is, a graph structure and a feature are combined, to restore a complete feature map applicable to an application scenario. In this way, graph computing in a specific application scenario can be performed.

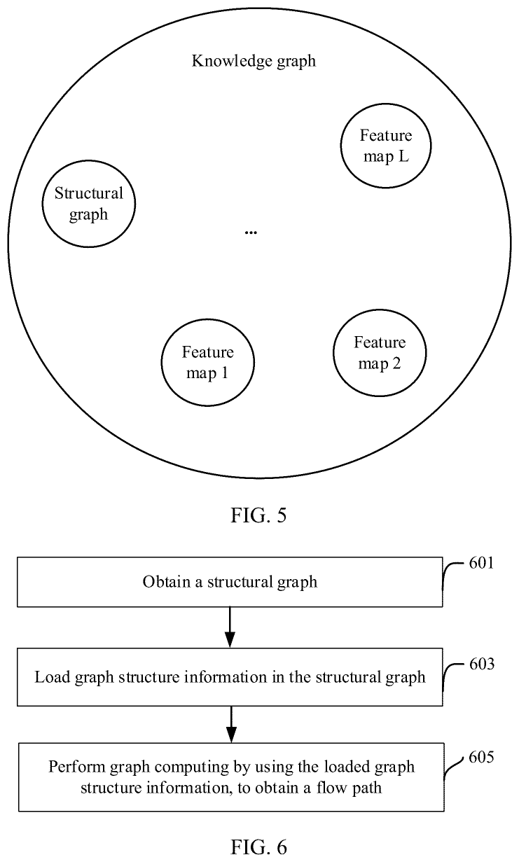

A structural graph, that is, a framework structure of a knowledge graph, is obtained by using the process shown in FIG. 2, and then a feature map corresponding to each application scenario is obtained by the process shown in FIG. 4. In this way, in the embodiments of this specification, the constructed knowledge graph can be shown in FIG. 5 (it can be understood that a quantity of feature maps shown in FIG. 5 is merely an example, where L is a positive integer), and includes a structural graph and at least one feature map.

After the structural graph is obtained by the process shown in FIG. 2, graph computing can be performed based on the structural graph, to obtain a flow path between vertexes. With reference to FIG. 6, the graph computing process includes the following steps.

Step 601: Obtain a structural graph. The structural graph can be obtained by using the method in any embodiment of this specification.

Step 603: Load graph structure information in the structural graph, where the graph structure information includes each vertex, each edge, a structural feature value of each vertex, a structural feature value of each edge, and a sequence of vertexes and edges.

Step 605: Perform graph computing by using the loaded graph structure information, to obtain a flow path.

In step 605, for different requirements, a flow path between vertexes can be obtained by using various methods for graph computing, for example, a traversal algorithm and a community detection algorithm.

In an embodiment of this specification, a specific implementation process of step 605 includes the following steps.

Step 6051: Load the graph structure information in the structural graph. The graph structure information includes each vertex, each edge, a structural feature value of each vertex, a structural feature value of each edge, and a sequence of vertexes and edges. That is, no application features of the vertex and the edge are loaded.

Step 6053: Perform message propagation, storage, and computing by using only the loaded graph structure information, and skip performing message propagation and storage by using application features.

In view of a current explosive increase in an information volume and graph computing such as graph computing at a level of tens of billions, based on the knowledge graph constructed in the embodiments of this specification, a quantity of features used in a graph computing process is greatly reduced, and graph computing efficiency is greatly improved. For example, in the graph computing process shown in FIG. 6, a computing party does not need to store values of all features of a large quantity of vertexes and edges, but needs to store only values of structural features of each vertex and edge. Therefore, occupation of storage resources is greatly reduced. For another example, in the graph computing process shown in FIG. 6, values of all features of a large quantity of vertexes and edges do not need to be propagated between vertexes by using a message, but only values of structural features need to be propagated by using a message. Therefore, bandwidth resources are greatly saved. For another example, in the graph computing process shown in FIG. 6, values of all features of a large quantity of vertexes and edges do not need to be involved in the computing process, but only values of structural features need to be involved in the computing process. Therefore, computing resources of a computing party are greatly saved.

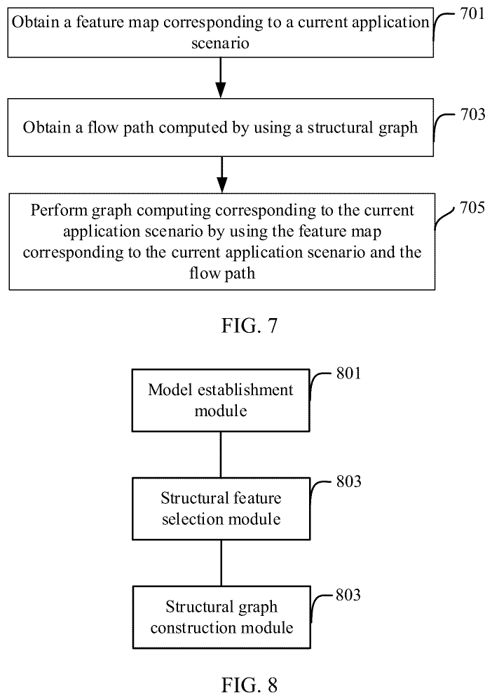

After a feature map corresponding to an application scenario is obtained by using the process shown in FIG. 4 and a flow path between vertexes is obtained by using the process shown in FIG. 6, different service analysis can be performed in different application scenarios. With reference to FIG. 7, the following steps are specifically included.

Step 701: Obtain a feature map corresponding to a current application scenario.

Step 703: Obtain a flow path computed by using a structural graph.

Step 705: Perform graph computing corresponding to the current application scenario by using the feature map corresponding to the current application scenario and the flow path.

For example, for graph computing of a temporal transaction service, a complete temporal flow path of each fund can be computed by using the computing process in step 605, and the temporal flow path can be used in a plurality of subsequent different application scenarios. For example, for a violation service of money laundering, graph computing is performed based on the procedure shown in FIG. 7 and by using a feature map corresponding to an application scenario of money laundering and the flow path, to obtain information indicating whether a user is involved in the violation service of money laundering. For another example, for a violation service of fraud, graph computing is performed based on the procedure shown in FIG. 7 and by using a feature map corresponding to an application scenario of fraud and the flow path, to obtain information indicating whether a user is involved in the violation service of fraud.

The method in the embodiments of this specification can be applied to construction and graph computing of various types of knowledge graphs.

For example, the method in the embodiments of this specification can be applied to construction and graph computing of a temporal knowledge graph, for example, construction and corresponding graph computing of a knowledge graph of the temporal transaction service.

For another example, the method in the embodiments of this specification is applied to construction and graph computing of a non-temporal knowledge graph, for example, construction and graph computing of a knowledge graph of an event type. In such a knowledge graph, for example, an enterprise can be a vertex, an event such as a price increase event of a product can be an edge, an ID of the enterprise can be a structural feature of the vertex, other information such as an establishment time, a relationship indicating whether the enterprise is a subsidiary of another company, an establishment location, and a legal person of the enterprise can be an application feature of the vertex, an ID of the event can be a structural feature of the edge, and a time, a location, content, or the like of the event can be an application feature of the edge. Based on the method shown in FIG. 2, a framework structure of a knowledge graph, that is, a structural graph, for an event service can be obtained. Then, for different application scenarios, for example, an application scenario for analyzing a cause why a share price of an enterprise rises and an application scenario for analyzing a profit or loss situation of an enterprise, feature maps corresponding to different application scenarios can be obtained based on the method in FIG. 4. Based on the structural graph obtained in FIG. 2, a flow path between enterprises based on an event impact relationship can be obtained. Based on the feature map obtained in FIG. 4 and the flow path obtained in FIG. 6, a root cause of event impact can be analyzed for an application scenario.

In an embodiment of this specification, a knowledge graph construction apparatus is provided. With reference to FIG. 8, the apparatus includes: a model establishment module 801, configured to: model each piece of first-type service data as a vertex in a graph; and model each piece of second-type service data as an edge in the graph; a structural feature selection module 802, configured to: obtain a structural feature value corresponding to each vertex based on a predetermined structural feature corresponding to the first-type service data; and obtain a structural feature value corresponding to each edge based on a predetermined structural feature corresponding to the second-type service data, where the structural feature is a feature commonly used in at least two application scenarios; and a structural graph construction module 803, configured to perform modeling by using each vertex, the structural feature value of the vertex, each edge, and the structural feature value of the edge, to obtain a structural graph, where each vertex and each edge in the structural graph are mounted with corresponding structural feature values.

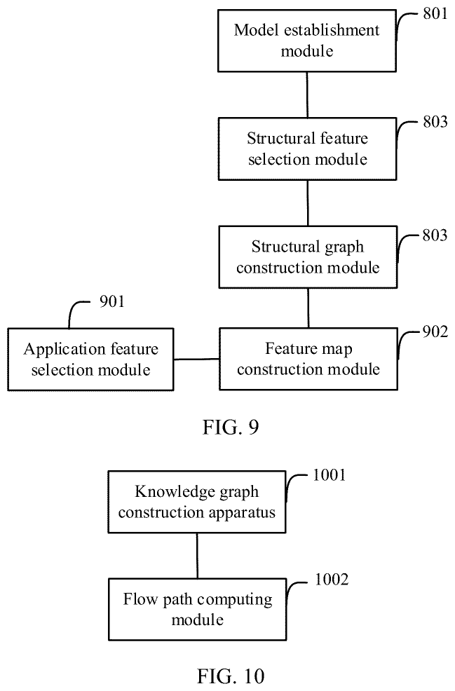

With reference to FIG. 9, in an embodiment of the apparatus in this specification, the apparatus further includes: an application feature selection module 901, configured to: for each vertex in the structural graph, obtain a current application feature corresponding to a current application scenario from application features corresponding to the vertex; and for each edge in the structural graph, obtain a current application feature corresponding to the current application scenario from application features corresponding to the edge; where the application feature is different from the structural feature; and a feature map construction module 902, configured to: for each vertex in the structural graph, mount a feature value of the current application feature corresponding to the vertex to the vertex, and for each edge in the structural graph, mount a feature value of the current application feature corresponding to the edge to the edge, to form a feature map corresponding to the current application scenario.

In an embodiment of the apparatus in this specification described with reference to FIG. 9, the apparatus can further include a graph feature library; where the graph feature library is used to store and dynamically update a correspondence between a global ID of each vertex and application features of the vertex, and store and dynamically update a correspondence between a global ID of each edge and application features of the edge; and the application feature selection module 901 is configured to: find application features corresponding to the global ID of the vertex from the graph feature library, and select the current application feature applicable to the current application scenario from the found application features; and find application features corresponding to the global ID of the edge from the graph feature library, and select the current application feature applicable to the current application scenario from the found application features.

In an embodiment of the apparatus in this specification, the apparatus is applied to construction of a temporal knowledge graph, and can be specifically applied to construction of a knowledge graph of a temporal transaction service; the first-type service data includes account information; the second-type service data includes a transaction behavior; a structural feature of the vertex includes an account ID; and a structural feature of the edge includes at least one of the following: a time, a transaction ID, and an amount.

In an embodiment of this specification, a graph computing apparatus is further provided. With reference to FIG. 10, the apparatus includes a knowledge graph construction apparatus 1001 and a flow path computing module 1002. The knowledge graph construction apparatus 1001 is implemented by using the knowledge graph construction apparatus that is provided in any embodiment of this specification and that is described, for example, with reference to FIG. 8 or FIG. 9. The flow path computing module 1002 is configured to: load graph structure information in a structural graph, where the graph structure information includes each vertex, each edge, a structural feature value of each vertex, a structural feature value of each edge, and a sequence of vertexes and edges; and perform graph computing by using the loaded graph structure information, to obtain a flow path.

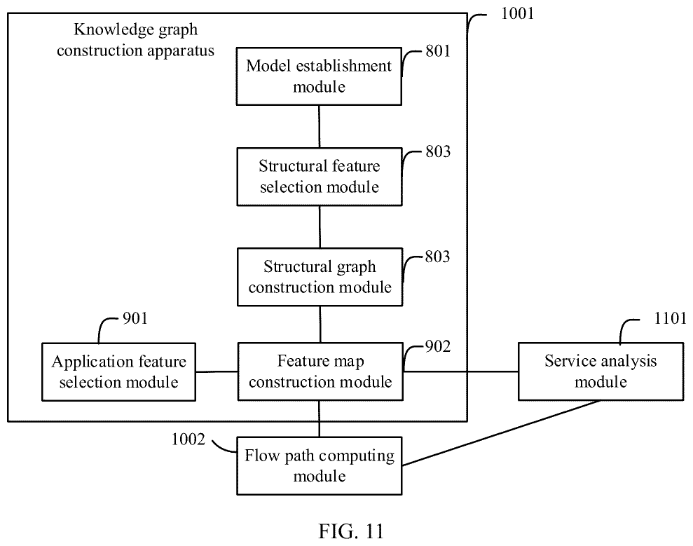

When the graph computing apparatus is implemented by using the knowledge graph construction apparatus described with reference to FIG. 9, with reference to FIG. 11, the graph computing apparatus can further include a service analysis module 1101, configured to perform graph computing corresponding to a current application scenario by using a feature map corresponding to the current application scenario and the flow path.

An embodiment of this specification provides a computer-readable storage medium. The computer-readable storage medium stores a computer program thereon, and when the computer program is executed in a computer, the computer is enabled to perform the method in any embodiment of this specification.

An embodiment of this specification provides a computing device, including a memory and a processor. The memory stores executable code, and when the processor executes the executable code, the method in any embodiment of this specification is implemented and performed.

It can be understood that the structure shown in the embodiments of this specification does not constitute a specific limitation on the apparatus in the embodiments of this specification. In some other embodiments of this specification, the above-mentioned apparatus can include more or fewer components than those shown in the figure, or combine some components, or split some components, or have different component arrangements. The components in the figure can be implemented by hardware, software, or a combination of software and hardware.

Content such as information exchange and an execution process between the modules in the apparatus and the system is based on the same idea as the method embodiments of this specification. Therefore, for detailed content, references can be made to descriptions in the method embodiments of this specification, and details are not described herein again.

The embodiments of this specification are described in a progressive manner. For same or similar parts of the embodiments, mutual references can be made to the embodiments. Each embodiment focuses on a difference from other embodiments. Particularly, the apparatus embodiments are basically similar to the method embodiments, and therefore are described briefly. For related parts, references can be made to related descriptions in the method embodiments.

A person skilled in the art should be aware that in the above-mentioned one or more examples, functions described in this specification can be implemented by hardware, software, firmware, or any combination thereof. When being implemented by software, these functions can be stored in a computer-readable medium or transmitted as one or more instructions or code on a computer-readable medium.

The objectives, technical solutions, and beneficial effects of this specification are further described in detail in the above-mentioned specific implementations. It should be understood that the above-mentioned descriptions are merely specific implementations of this specification, but are not intended to limit the protection scope of this specification. Any modification, equivalent replacement, improvement, and the like made based on the technical solutions of this specification shall fall within the protection scope of this specification.

1. A knowledge graph construction method, comprising:
modeling each piece of first-type service data as a vertex in a graph;
modeling each piece of second-type service data as an edge in the graph;
obtaining a structural feature value corresponding to each vertex based on a predetermined structural feature corresponding to the first-type service data;
obtaining a structural feature value corresponding to each edge based on a predetermined structural feature corresponding to the second-type service data, wherein the structural feature is a feature commonly used in at least two application scenarios; and
performing modeling by using each vertex, the structural feature value of the vertex, each edge, and the structural feature value of the edge, to obtain a structural graph.

2. The method according to claim 1, after the obtaining a structural graph, further comprising:
for each vertex in the structural graph, obtaining a current application feature corresponding to a current application scenario from application features corresponding to the first-type service data;
for each edge in the structural graph, obtaining a current application feature corresponding to the current application scenario from application features corresponding to the second-type service data;
wherein, the application feature is different from the structural feature; and
for each vertex in the structural graph, mounting a feature value of the current application feature corresponding to the vertex to the vertex, and for each edge in the structural graph, mounting a feature value of the current application feature corresponding to the edge to the edge, to form a feature map corresponding to the current application scenario.

3. The method according to claim 2, wherein
the method further comprises: setting corresponding global IDs for each vertex and each edge; and in a graph feature library, storing and dynamically updating a correspondence between the global ID of each vertex and application features of the vertex, and storing and dynamically updating a correspondence between the global ID of each edge and application features of the edge;
the obtaining a current application feature corresponding to a current application scenario from application features corresponding to the vertex comprises: finding application features corresponding to the global ID of the vertex from the graph feature library, and selecting the current application feature applicable to the current application scenario from the found application features; and
the obtaining a current application feature corresponding to the current application scenario from application features corresponding to the edge comprises: finding application features corresponding to the global ID of the edge from the graph feature library, and selecting the current application feature applicable to the current application scenario from the found application features.

4. The method according to claim 1, wherein the method is applied to construction of a temporal knowledge graph.

5. The method according to claim 4, wherein the method is applied to construction of a knowledge graph of a temporal transaction service;
the first-type service data comprises account information;
the second-type service data comprises a transaction behavior;
a structural feature of the vertex comprises an account ID; and
a structural feature of the edge comprises at least one of the following: a time, a transaction ID, and an amount.

6. A graph computing method, comprising:
obtaining a structural graph by using the method according to claim 1;
loading graph structure information in the structural graph, wherein the graph structure information comprises each vertex, each edge, a structural feature value of each vertex, a structural feature value of each edge, and a sequence of vertexes and edges; and
performing graph computing by using the loaded graph structure information, to obtain a flow path.

7. The method according to claim 6, after the obtaining a structural graph, further comprising: for each vertex in the structural graph, obtaining a current application feature corresponding to a current application scenario from application features corresponding to the first-type service data; for each edge in the structural graph, obtaining a current application feature corresponding to the current application scenario from application features corresponding to the second-type service data; wherein, the application feature is different from the structural feature; and for each vertex in the structural graph, mounting a feature value of the current application feature corresponding to the vertex to the vertex, and for each edge in the structural graph, mounting a feature value of the current application feature corresponding to the edge to the edge, to form a feature map corresponding to the current application scenario, wherein the graph computing method further comprises:
performing graph computing corresponding to a current application scenario by using the feature map corresponding to the current application scenario and the flow path.

8-11. (canceled)

12. A computing device, comprising a memory and a processor, wherein the memory stores executable code, and when the processor executes the executable code, the computing device is caused to:
model each piece of first-type service data as a vertex in a graph;
model each piece of second-type service data as an edge in the graph;
obtain a structural feature value corresponding to each vertex based on a predetermined structural feature corresponding to the first-type service data;
obtain a structural feature value corresponding to each edge based on a predetermined structural feature corresponding to the second-type service data, wherein the structural feature is a feature commonly used in at least two application scenarios; and
perform modeling by using each vertex, the structural feature value of the vertex, each edge, and the structural feature value of the edge, to obtain a structural graph.

13. The computing device according to claim 12, wherein the computing device is further caused to, after the obtaining a structural graph:
for each vertex in the structural graph, obtain a current application feature corresponding to a current application scenario from application features corresponding to the first-type service data;
for each edge in the structural graph, obtain a current application feature corresponding to the current application scenario from application features corresponding to the second-type service data;
wherein, the application feature is different from the structural feature; and
for each vertex in the structural graph, mount a feature value of the current application feature corresponding to the vertex to the vertex, and for each edge in the structural graph, mount a feature value of the current application feature corresponding to the edge to the edge, to form a feature map corresponding to the current application scenario.

14. The computing device according to claim 13, wherein the computing device is further caused to: set corresponding global IDs for each vertex and each edge; and in a graph feature library, store and dynamically update a correspondence between the global ID of each vertex and application features of the vertex, and store and dynamically update a correspondence between the global ID of each edge and application features of the edge;
the obtaining a current application feature corresponding to a current application scenario from application features corresponding to the vertex comprises: finding application features corresponding to the global ID of the vertex from the graph feature library, and selecting the current application feature applicable to the current application scenario from the found application features; and
the obtaining a current application feature corresponding to the current application scenario from application features corresponding to the edge comprises: finding application features corresponding to the global ID of the edge from the graph feature library, and selecting the current application feature applicable to the current application scenario from the found application features.

15. The computing device according to claim 12, wherein the knowledge graph is a temporal knowledge graph.

16. The computing device according to claim 12, wherein the computing device is further caused to:
load graph structure information in the structural graph, wherein the graph structure information comprises each vertex, each edge, a structural feature value of each vertex, a structural feature value of each edge, and a sequence of vertexes and edges; and
perform graph computing by using the loaded graph structure information, to obtain a flow path.

17. The computing device according to claim 16, wherein the computing device is further caused to:
after the obtaining a structural graph, for each vertex in the structural graph, obtain a current application feature corresponding to a current application scenario from application features corresponding to the first-type service data; for each edge in the structural graph, obtain a current application feature corresponding to the current application scenario from application features corresponding to the second-type service data; wherein, the application feature is different from the structural feature; and for each vertex in the structural graph, mount a feature value of the current application feature corresponding to the vertex to the vertex, and for each edge in the structural graph, mount a feature value of the current application feature corresponding to the edge to the edge, to form a feature map corresponding to the current application scenario,
perform graph computing corresponding to a current application scenario by using the feature map corresponding to the current application scenario and the flow path.

18. A non-transitory computer-readable storage medium comprising a computer program stored thereon, which when executed by a processor causes the processor to:
model each piece of first-type service data as a vertex in a graph;
model each piece of second-type service data as an edge in the graph;
obtain a structural feature value corresponding to each vertex based on a predetermined structural feature corresponding to the first-type service data;
obtain a structural feature value corresponding to each edge based on a predetermined structural feature corresponding to the second-type service data, wherein the structural feature is a feature commonly used in at least two application scenarios; and
perform modeling by using each vertex, the structural feature value of the vertex, each edge, and the structural feature value of the edge, to obtain a structural graph.

19. The non-transitory computer-readable storage medium according to claim 18, wherein the computer program when executed by the processor further causes the processor to, after the obtaining a structural graph:
for each vertex in the structural graph, obtain a current application feature corresponding to a current application scenario from application features corresponding to the first-type service data;
for each edge in the structural graph, obtain a current application feature corresponding to the current application scenario from application features corresponding to the second-type service data;
wherein, the application feature is different from the structural feature; and
for each vertex in the structural graph, mount a feature value of the current application feature corresponding to the vertex to the vertex, and for each edge in the structural graph, mount a feature value of the current application feature corresponding to the edge to the edge, to form a feature map corresponding to the current application scenario.

20. The non-transitory computer-readable storage medium according to claim 19, wherein the computer program when executed by the processor further causes the processor to:
set corresponding global IDs for each vertex and each edge; and in a graph feature library, store and dynamically update a correspondence between the global ID of each vertex and application features of the vertex, and store and dynamically update a correspondence between the global ID of each edge and application features of the edge;
the obtaining a current application feature corresponding to a current application scenario from application features corresponding to the vertex comprises: finding application features corresponding to the global ID of the vertex from the graph feature library, and selecting the current application feature applicable to the current application scenario from the found application features; and
the obtaining a current application feature corresponding to the current application scenario from application features corresponding to the edge comprises: finding application features corresponding to the global ID of the edge from the graph feature library, and selecting the current application feature applicable to the current application scenario from the found application features.

21. The non-transitory computer-readable storage medium according to claim 18, wherein the knowledge graph is a temporal knowledge graph.

22. The non-transitory computer-readable storage medium according to claim 21, wherein the knowledge graph is a knowledge graph of a temporal transaction service;
the first-type service data comprises account information;
the second-type service data comprises a transaction behavior;
a structural feature of the vertex comprises an account ID; and
a structural feature of the edge comprises at least one of the following: a time, a transaction ID, and an amount.

23. The non-transitory computer-readable storage medium according to claim 18, wherein the computer program when executed by the processor further causes the processor to:
load graph structure information in the structural graph, wherein the graph structure information comprises each vertex, each edge, a structural feature value of each vertex, a structural feature value of each edge, and a sequence of vertexes and edges; and
perform graph computing by using the loaded graph structure information, to obtain a flow path.

24. The non-transitory computer-readable storage medium according to claim 23, wherein the computer program when executed by the processor further causes the processor to:
after the obtaining a structural graph, for each vertex in the structural graph, obtain a current application feature corresponding to a current application scenario from application features corresponding to the first-type service data; for each edge in the structural graph, obtain a current application feature corresponding to the current application scenario from application features corresponding to the second-type service data; wherein, the application feature is different from the structural feature; and for each vertex in the structural graph, mount a feature value of the current application feature corresponding to the vertex to the vertex, and for each edge in the structural graph, mount a feature value of the current application feature corresponding to the edge to the edge, to form a feature map corresponding to the current application scenario,
perform graph computing corresponding to a current application scenario by using the feature map corresponding to the current application scenario and the flow path.
